(19) United States
(12) Patent Application Publication
(10) Pub. No.: US 2022/0373659 A1
(43) Pub. Date: Nov. 24, 2022

(54) SOLID-STATE IMAGING ELEMENT, ELECTRONIC DEVICE, AND METHOD FOR CONTROLLING SOLID-STATE IMAGING ELEMENT

(71) Applicant: SONY SEMICONDUCTOR SOLUTIONS CORPORATION, KANAGAWA (JP)

(72) Inventor: MASAMUNE HAMAMATSU, KANAGAWA (JP)

(21) Appl. No.: 17/753,753

(22) PCT Filed: Jul. 14, 2020
(86) PCT No.: PCT/JP2020/027349

§ 371 Date: Mar. 14, 2022

(30) Foreign Application Priority Data
Sep. 24, 2019 (JP) 2019-172486

(51) Int. Cl. G01S 7/4865; G01S 17/894

(52) U.S. Cl. CPC G01S 7/4865; G01S 17/894

(57) ABSTRACT

In a solid-state imaging element that measures a distance, distance measurement accuracy is improved.

The solid-state imaging element includes a photon number detection unit, a histogram generation unit, and a distance measurement unit. The photon number detection unit detects the number of photons incident on a pixel array unit over a predetermined number of times and outputs a detection result including the number of photons and a detection timing. The histogram generation unit generates, for each number of photons, a histogram indicating a detection frequency of the number of photons as a frequency for each detection timing, on the basis of the detection result. The distance measurement unit measures a distance to a predetermined object on the basis of the histogram generated.

### TECHNICAL FIELD

The present technology relates to a solid-state imaging element. Specifically, the present technology relates to a solid-state imaging element that counts the number of photons incident, an electronic device, and a method for controlling the solid-state imaging element.

### BACKGROUND ART

In an electronic device having a distance measurement function, a distance measurement method called a time of flight (ToF) method is conventionally known. The ToF method is a method of measuring a distance by irradiating an object with irradiation light from a distance measurement device and obtaining a round-trip time until the irradiation light is reflected and returned. For example, a distance measurement device has been devised in which histograms for respective pixels are synthesized, and a time to a peak of a synthesized histogram is converted into a distance (see, for example, Patent Document 1).

### CITATION LIST

### Patent Document

### Patent Document 1: Japanese Patent Application Laid-Open No. 2016-176750

### SUMMARY OF THE INVENTION

### Problems to be Solved by the Invention

In the above-described conventional technology, a signal to noise (S/N) ratio can be improved by synthesizing the histograms for the respective pixels as compared with a case where the histograms are not synthesized. However, in the above-described device, in a case where there is a lot of noise such as background light, in a case where disturbance such as instantaneous light emission of an external light source occurs, or the like, distance measurement accuracy may decrease due to the noise or the disturbance.

The present technology has been made in view of such a situation, and an object thereof is to improve the measurement accuracy in a solid-state imaging element that measures a distance.

### Solutions to Problems

The present technology has been made to solve the above-described problem, and a first aspect thereof is a solid-state imaging element and a method for controlling the same, the solid-state imaging element including: a photon number detection unit that detects the number of photons incident on a pixel array unit over a predetermined number of times and outputs a detection result including the number of photons and a detection timing; a histogram generation unit that generates, for each number of photons, a histogram indicating a detection frequency of the number of photons as a frequency for each detection timing, on the basis of the detection result; and a distance measurement unit that measures a distance to a predetermined object on the basis of the histogram generated. As a result, there is an effect that the distance measurement accuracy is improved.

Furthermore, in the first aspect, the histogram generation unit may include: an individual histogram generation unit that generates the histogram as an individual histogram for each number of photons on the basis of the detection result; and a histogram synthesis unit that synthesizes histograms in which a degree of variation does not exceed a predetermined threshold value among a plurality of the individual histograms and outputs a synthesized histogram to the distance measurement unit. As a result, there is an effect that influence of noise or disturbance is suppressed.

Furthermore, in the first aspect, the histogram generation unit may further include a weight setting unit that sets a weight depending on the degree of variation for each of the individual histograms, and the histogram synthesis unit may perform weighted addition of the detection frequency of each of the individual histograms by the set weight. As a result, there is an effect that the histograms are synthesized at ratios depending on the degrees of variation.

Furthermore, in the first aspect, the degree of variation may be a standard deviation. As a result, there is an effect that the histograms are synthesized at ratios depending on the standard deviations.

Furthermore, in the first aspect, the histogram generation unit may include: an individual histogram generation unit that generates the histogram as an individual histogram for each number of photons on the basis of the detection result; and a selection unit that selects a histogram of which the degree of variation is minimum among a plurality of the individual histograms and outputs the histogram selected to the distance measurement unit. As a result, there is an effect that an amount of calculation is reduced as compared with the case of synthesizing.

Furthermore, in the first aspect, the pixel array unit may be divided into a plurality of pixel blocks in each of which a plurality of pixels is arranged, the photon number detection unit may detect the number of photons for each of the plurality of pixel blocks, the histogram generation unit may generate the histogram for each of the plurality of pixel blocks, and the distance measurement unit may measure the distance for each of the plurality of pixel blocks. As a result, there is an effect that the distance is measured in the plurality of pixel blocks.

Furthermore, a second aspect of the present technology is an electronic device including: a light emitting unit that emits light in synchronization with a predetermined synchronization signal; a photon number detection unit that detects the number of photons incident on a pixel array unit over a predetermined number of times and outputs a detection result including the number of photons and a detection timing; a histogram generation unit that generates, for each number of photons, a histogram indicating a detection frequency of the number of photons as a frequency for each detection timing, on the basis of the detection result; and a distance measurement unit that measures a distance to a predetermined object on the basis of the histogram generated. As a result, there is an effect that the distance measurement accuracy by the ToF method is improved.

### BRIEF DESCRIPTION OF DRAWINGS

FIG. 1 is a block diagram illustrating a configuration example of a distance measurement module in a first embodiment of the present technology.

FIG. 2 is a diagram illustrating an example of a stacked structure of a solid-state imaging element in the first embodiment of the present technology.

FIG. 3 is a plan view illustrating a configuration example of a light receiving chip in the first embodiment of the present technology.

FIG. 4 is a plan view illustrating a configuration example of a logic chip in the first embodiment of the present technology.

FIG. 5 is a block diagram illustrating a configuration example of a current signal generation unit in the first embodiment of the present technology.

FIG. 6 is a circuit diagram illustrating a configuration example of a pixel in the first embodiment of the present technology.

FIG. 7 is a plan view illustrating a wiring example in a pixel array unit in the first embodiment of the present technology.

FIG. 8 is a block diagram illustrating a configuration example of an analog-digital conversion unit in the first embodiment of the present technology.

FIG. 9 is a circuit diagram illustrating a configuration example of a simultaneous reaction number detection circuit in the first embodiment of the present technology.

FIG. 10 is a block diagram illustrating a configuration example of a signal processing unit in the first embodiment of the present technology.

FIG. 11 is a block diagram illustrating a configuration example of a histogram generation unit in the first embodiment of the present technology.

FIG. 12 is a block diagram illustrating a configuration example of a weight setting unit in the first embodiment of the present technology.

FIG. 13 is a diagram illustrating an example of an individual histogram of a one-reaction frequency histogram generation unit when noise occurs in the first embodiment of the present technology.

FIG. 14 is a diagram illustrating an example of an individual histogram of a two-reaction frequency histogram generation unit when noise occurs in the first embodiment of the present technology.

FIG. 15 is a diagram illustrating an example of an individual histogram of a three-reaction frequency histogram generation unit when noise occurs in the first embodiment of the present technology.

FIG. 16 is a diagram illustrating an example of an individual histogram of a four-reaction frequency histogram generation unit when noise occurs in the first embodiment of the present technology.

FIG. 17 is a diagram illustrating an example of the individual histogram of the one-reaction frequency histogram generation unit when disturbance occurs in the first embodiment of the present technology.

FIG. 18 is a diagram illustrating an example of the individual histogram of the two-reaction frequency histogram generation unit when disturbance occurs in the first embodiment of the present technology.

FIG. 19 is a diagram illustrating an example of the individual histogram of the three-reaction frequency histogram generation unit when disturbance occurs in the first embodiment of the present technology.

FIG. 20 is a diagram illustrating an example of the individual histogram of the four-reaction frequency histogram generation unit when disturbance occurs in the first embodiment of the present technology.

FIG. 21 is a diagram illustrating an example of the individual histogram of the one-reaction frequency histogram generation unit when noise and disturbance occur in the first embodiment of the present technology.

FIG. 22 is a diagram illustrating an example of the individual histogram of the two-reaction frequency histogram generation unit when noise and disturbance occur in the first embodiment of the present technology.

FIG. 23 is a diagram illustrating an example of the individual histogram of the three-reaction frequency histogram generation unit when noise and disturbance occur in the first embodiment of the present technology.

FIG. 24 is a diagram illustrating an example of the individual histogram of the four-reaction frequency histogram generation unit when noise and disturbance occur in the first embodiment of the present technology.

FIG. 25 is a diagram illustrating an example of setting weights in the first embodiment of the present technology.

FIG. 26 is a diagram for explaining entire processing from detection of the number of simultaneous reactions to distance measurement in the first embodiment of the present technology.

FIG. 27 is a flowchart illustrating an example of operation of a pixel in the first embodiment of the present technology.

FIG. 28 is a flowchart illustrating an example of operation of an analog-digital conversion unit in the first embodiment of the present technology.

FIG. 29 is a flowchart illustrating an example of operation of the signal processing unit in the first embodiment of the present technology.

FIG. 30 is a block diagram illustrating a configuration example of a histogram generation unit in a modification of the first embodiment of the present technology.

FIG. 31 is a block diagram illustrating an example of a schematic configuration of a vehicle control system.

FIG. 32 is an explanatory diagram illustrating an example of installation positions of a vehicle exterior information detecting unit and an imaging unit.

### MODE FOR CARRYING OUT THE INVENTION

The following is a description of a mode for carrying out the present technology (the mode will be hereinafter referred to as the embodiment). The description will be made in the following order.

1. First embodiment (example of generating histogram for each number of simultaneous reactions)

2. Application example to mobile body

### 1. First Embodiment

[Configuration Example of Distance Measurement Module]

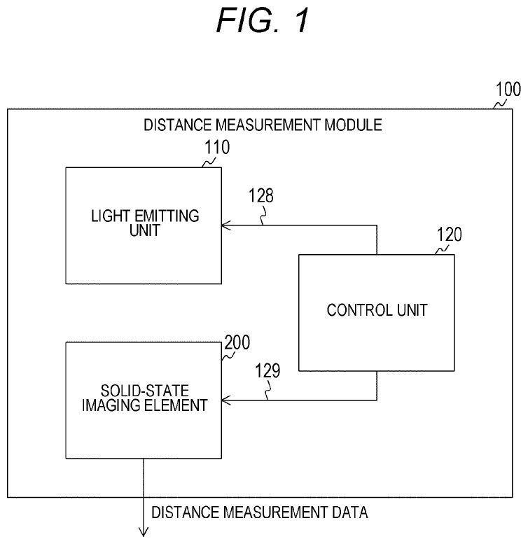

FIG. 1 is a block diagram illustrating a configuration example of a distance measurement module 100 in an embodiment of the present technology. The distance measurement module 100 is an electronic device that measures a distance by a ToF method, and includes a light emitting unit 110, a control unit 120, and a solid-state imaging element 200. Note that, the distance measurement module 100 is an example of an electronic device described in the claims.

The light emitting unit 110 intermittently emits irradiation light to irradiate an object. The light emitting unit 110 generates the irradiation light in synchronization with a square wave synchronization signal, for example. Furthermore, for example, a light emitting diode is used as the light emitting unit 110, and near-infrared light or the like is used as the irradiation light. Note that, the motion signal is not limited to the square wave as long as the motion signal is a periodic signal. For example, the synchronization signal may be a sine wave. Furthermore, the irradiation light is not limited to the near-infrared light, and may be visible light or the like.

The control unit 120 controls the light emitting unit 110 and the solid-state imaging element 200. The control unit 120 generates a synchronization signal and supplies the synchronization signal to the light emitting unit 110 and the solid-state imaging element 200 via signal lines 128 and 129. A frequency of the synchronization signal is, for example, 20 megahertz (MHz). Note that, the frequency of the synchronization signal is not limited to 20 megahertz (MHz) and may be 5 megahertz (MHz) or the like.

The solid-state imaging element 200 receives reflected light with respect to intermittent irradiation light and measures a distance to an object by the ToF method. The solid-state imaging element 200 generates distance measurement data indicating the measured distance and outputs the distance measurement data to the outside.

[Configuration Example of Solid-State Imaging Element]

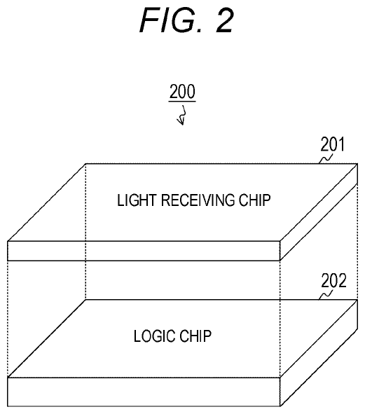

FIG. 2 is a diagram illustrating an example of a stacked structure of the solid-state imaging element 200 in the embodiment of the present technology. The solid-state imaging element 200 includes a light receiving chip 201 and a logic chip 202 stacked on the light receiving chip 201. A signal line for transmitting a signal is provided between these chips.

[Configuration Example of Light Receiving Chip]

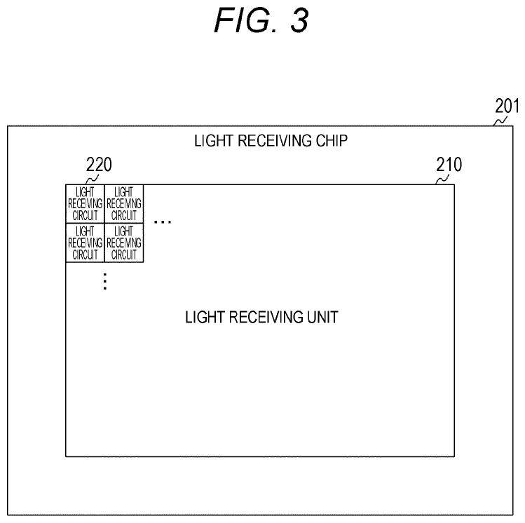

FIG. 3 is a plan view illustrating a configuration example of the light receiving chip 201 in the embodiment of the present technology. The light receiving chip 201 is provided with a light receiving unit 210, and the light receiving unit 210 is provided with a plurality of light receiving circuits 220 in a two-dimensional lattice pattern. Details of the light receiving circuits 220 will be described later.

[Configuration Example of Logic Chip]

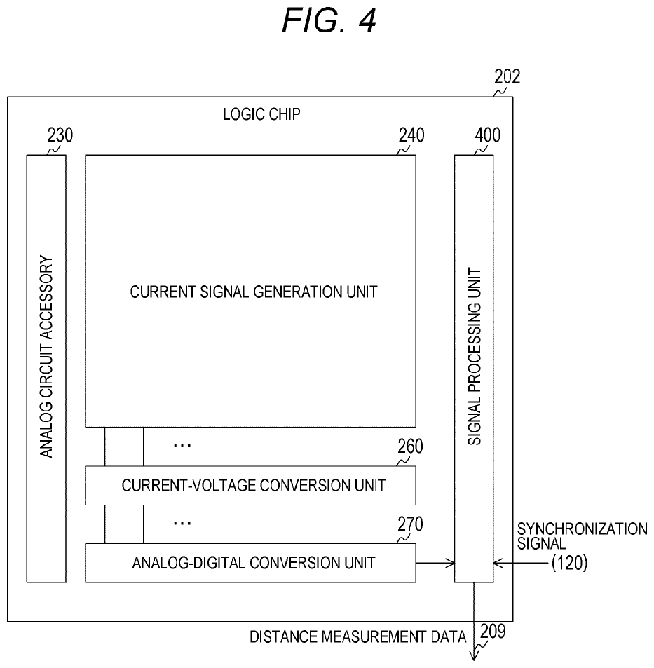

FIG. 4 is a block diagram illustrating a configuration example of the logic chip 202 in the embodiment of the present technology. In the logic chip 202, an analog circuit accessory 230, a current signal generation unit 240, a current-voltage conversion unit 260, an analog-digital conversion unit 270, and a signal processing unit 400 are arranged.

The analog circuit accessory 230 controls operations of the analog-digital conversion unit 270 and the signal processing unit 400.

The current signal generation unit 240 generates a current signal depending on the number of photons incident on the light receiving unit 210. The current signal generation unit 240 supplies the current signal to the current-voltage conversion unit 260.

The current-voltage conversion unit 260 converts the current signal into a voltage signal and outputs the voltage signal to the analog-digital conversion unit 270.

The analog-digital conversion unit 270 converts the voltage signal into a digital signal indicating the number of photons incident. The analog-digital conversion unit 270 supplies the digital signal to the signal processing unit 400.

The signal processing unit 400 processes the digital signal in synchronization with the synchronization signal from the control unit 120 and generates distance measurement data.

[Configuration Example of Current Signal Generation Unit]

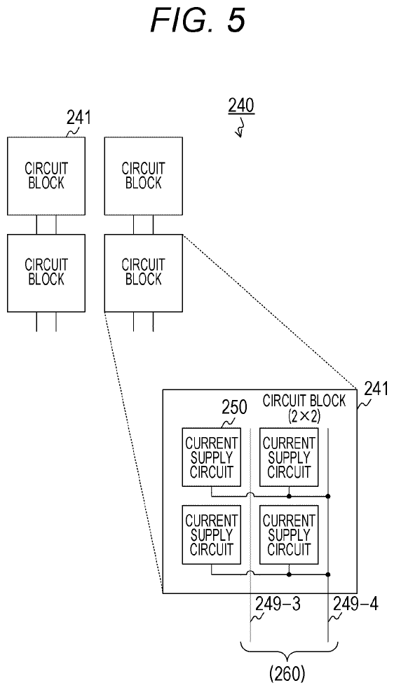

FIG. 5 is a block diagram illustrating a configuration example of the current signal generation unit 240 in a first embodiment of the present technology. A plurality of circuit blocks 241 is arranged in the current signal generation unit 240. A plurality of current supply circuits 250 is arranged in each of the circuit blocks 241. For example, in the circuit block 241, the current supply circuits 250 of two rows×two columns are arranged in a two-dimensional lattice pattern. The current supply circuits 250 are provided for the respective light receiving circuits 220 of the light receiving chip 201, and are connected to the corresponding light receiving circuits 220 via signal lines. A circuit including one of the light receiving circuits 220 and one of the current supply circuits 250 corresponding to the one light receiving circuit 220 is used to generate distance measurement data for one pixel in a distance measurement image.

[Configuration Example of Pixel]

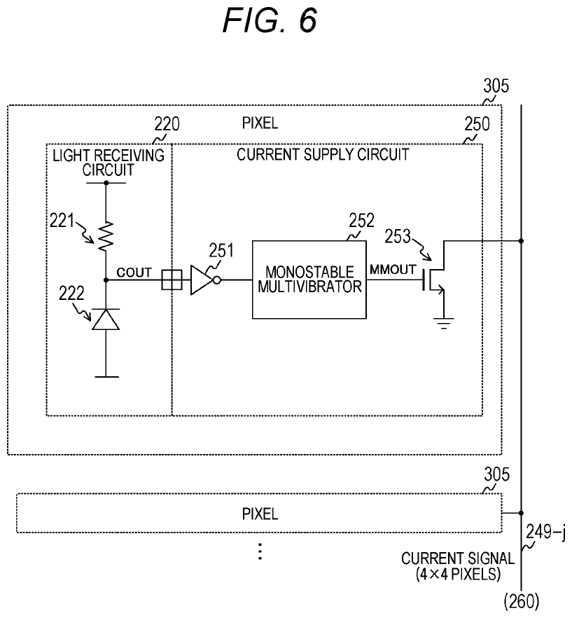

FIG. 6 is a circuit diagram illustrating a configuration example of a pixel 305 in the first embodiment of the present technology. A circuit including the light receiving circuit 220 in the light receiving chip 201 and the corresponding current supply circuit 250 functions as one pixel 305. Furthermore, the current supply circuits 250 of two rows×two columns in the circuit block 241 are connected in common to one signal line 249-j (j is an integer). The signal line 249-j functions as a bus that transmits a signal from each of the current supply circuits 250.

The light receiving circuit 220 includes a resistor 221 and a photoelectric conversion element 222. The resistor 221 and the photoelectric conversion element 222 are connected in series between a power supply terminal and a ground terminal.

The photoelectric conversion element 222 photoelectrically converts incident light and outputs a photocurrent. The cathode of the photoelectric conversion element 222 is connected to a terminal of a power supply potential via the resistor 221, and the anode is connected to a terminal (ground terminal or the like) of a potential lower than the power supply potential. As a result, a reverse bias is applied to the photoelectric conversion element 222. Furthermore, the photocurrent flows in a direction from the cathode to the anode of the photoelectric conversion element 222.

As the photoelectric conversion element 222, for example, an avalanche photodiode is used that is capable of detecting presence or absence of incidence of one photon by amplifying a photocurrent. Furthermore, it is desirable to use an SPAD among avalanche photodiodes.

One end of the resistor 221 is connected to the terminal of the power supply potential, and the other end is connected to the cathode of the photoelectric conversion element 222. Each time a photon is incident, a photocurrent flows through the resistor 221, and a cathode potential COUT of the photoelectric conversion element 222 drops to a value lower than the power supply potential.

The current supply circuit 250 supplies a current signal to the current-voltage conversion unit 260 via the signal line 249-j when the cathode potential of the photoelectric conversion element 222 drops (in other words, a photon is incident). The current supply circuit 250 includes, for example, an inverter 251, a monostable multivibrator 252, and a current source transistor 253. As the current source transistor 253, for example, an n-channel metal oxide semiconductor (nMOS) transistor is used. Note that, the monostable multivibrator 252 is provided as necessary.

The inverter 251 inverts a signal of the cathode potential COUT and supplies an inverted signal to the monostable multivibrator 252.

The monostable multivibrator 252 outputs a pulse signal MMOUT having a predetermined pulse width to the current source transistor 253 depending on an inverted signal of the high level from the inverter 251.

The current source transistor 253 generates a current signal depending on the pulse signal MMOUT and supplies the current signal to the signal line 249-j.

Note that, the pixel 305 generates a pulse signal by the inverter 251 and the monostable multivibrator 252, but is not limited to have this configuration. The pixel 305 can also generate a pulse signal only by the inverter 251.

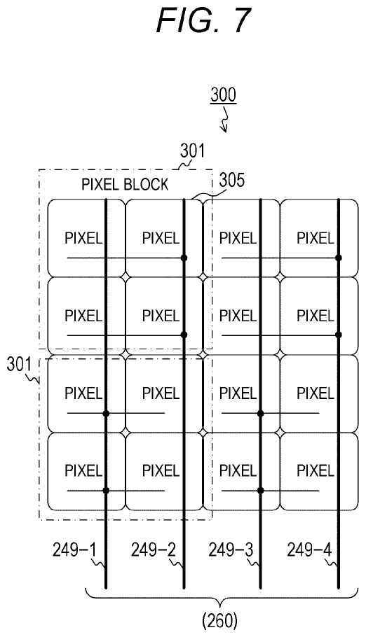

FIG. 7 is a plan view illustrating a wiring example in a pixel array unit 300 in the first embodiment of the present technology. A plurality of the pixels 305 is arranged in a two-dimensional lattice pattern in the pixel array unit 300. Furthermore, the pixel array unit 300 is divided into a plurality of pixel blocks 301 each including the pixels 305 of two rows×two columns. Furthermore, the signal line 249-j is wired in the vertical direction in a column j of the pixel 305.

Each signal line 249-j is connected to the pixels 305 in the pixel blocks 301 different from each other. For example, the pixel block 301 including the first row and the second row is connected to a signal line 249-2, and the pixel block 301 including the third row and the fourth row is connected to a signal line 249-1. Signal lines 249-3 and 249-4 are similarly connected to the pixel blocks 301 different from each other.

Four pixels 305 in the pixel block 301 corresponding to the signal line 249-j are connected in common to the signal line 249-j. Furthermore, each signal line 249-j is connected to the current-voltage conversion unit 260.

With a connection configuration exemplified in the figure, the four pixels 305 in the pixel block 301 supply current signals to the signal line 249-j to which the four pixels 305 are connected in common. Among these pixels 305, in a case where there are two or more pixels 305 on which photons are incident substantially simultaneously, the current signals generated by the two or more pixels 305 merge in the signal line 249-j and are input to the current-voltage conversion unit 260. The current-voltage conversion unit 260 converts a current signal into a voltage signal by a resistor or the like for each column. As a result, a voltage signal is generated of a level depending on the number of photons incident substantially simultaneously.

Note that, the number of pixels in the pixel block 301 is four in two rows×two columns, but is not limited to this configuration. The number of rows may be other than two, and the number of columns may be other than two. Furthermore, the number of pixels in the pixel block 301 may be other than four.

[Configuration Example of Analog-Digital Conversion Unit]

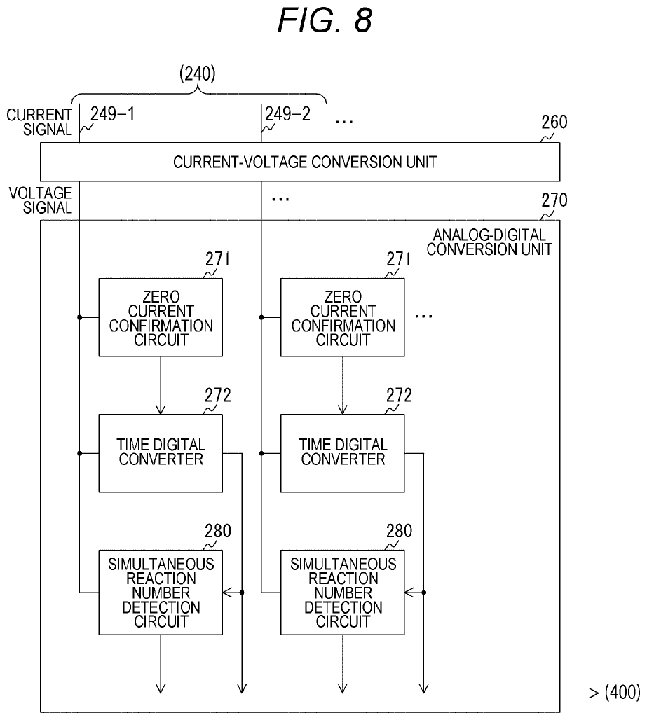

FIG. 8 is a block diagram illustrating a configuration example of the analog-digital conversion unit 270 in the first embodiment of the present technology. The analog-digital conversion unit 270 includes a plurality of zero current confirmation circuits 271, a plurality of time digital converters 272, and a plurality of simultaneous reaction number detection circuits 280. The zero current confirmation circuit 271, the time digital converter 272, and the simultaneous reaction number detection circuit 280 are arranged for each column and are connected in common to the signal line 249-j of a corresponding column.

The zero current confirmation circuit 271 confirms whether or not a current flowing through the corresponding signal line 249-j is zero, in other words, whether or not a current signal is output via the signal line 249-j. The zero current confirmation circuit 271 supplies a confirmation result to the time digital converter 272.

In a case where a zero current is confirmed for the corresponding signal line 249-j, the time digital converter 272 converts an elapsed time from a light emission timing of the light emitting unit 110 to a drop of the cathode potential into a digital value. Furthermore, the time digital converter 272 supplies the converted digital value to the simultaneous reaction number detection circuit 280 and the signal processing unit 400.

The simultaneous reaction number detection circuit 280 detects the number of photons incident substantially simultaneously in a corresponding pixel block 301 as the number of simultaneous reactions on the basis of the voltage signal from the signal line 249-j and the digital value from the time digital converter 272. Here, “substantially simultaneously” means a case where incident timings of a plurality of photons are completely simultaneous, or a case where the incident timings are not completely simultaneous, but there is only a time difference in which a part of pulse periods of corresponding pulse signals overlap each other. The simultaneous reaction number detection circuit 280 supplies a digital signal indicating a detection result to the signal processing unit 400.

The signal processing unit 400 generates a histogram for each pixel block 301 on the basis of the detection result from the analog-digital conversion unit 270. A method for generating the histogram will be described later. Then, the signal processing unit 400 detects a timing of a peak value of the histogram as an incident timing of the reflected light, and converts a round-trip time from an irradiation timing of the irradiation light to the incident timing of the reflected light into the distance to the object.

[Configuration Example of Simultaneous Reaction Number Detection Circuit]

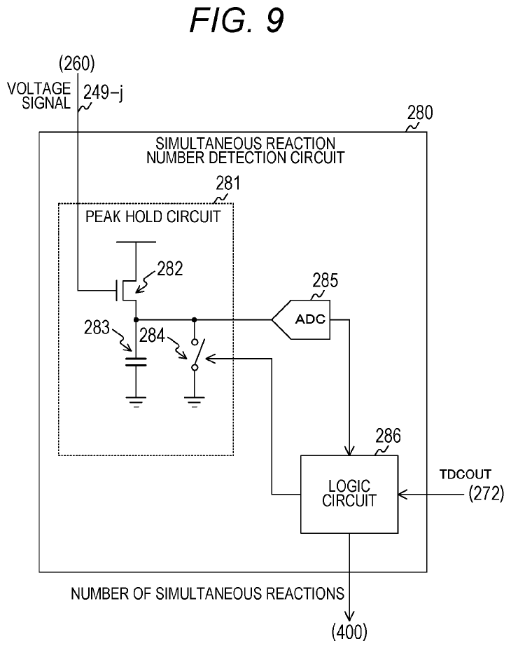

FIG. 9 is a circuit diagram illustrating a configuration example of the simultaneous reaction number detection circuit 280 in the first embodiment of the present technology. The simultaneous reaction number detection circuit 280 includes a peak hold circuit 281, an analog to digital converter (ADC) 285, and a logic circuit 286.

The peak hold circuit 281 holds a peak value of the voltage signal transmitted via the corresponding signal line 249-j. The peak hold circuit 281 includes an nMOS transistor 282, a capacitor 283, and a reset switch 284.

The nMOS transistor 282 and the capacitor 283 are inserted in series between the power supply terminal and the ground terminal. The gate of the nMOS transistor 282 is connected to the corresponding signal line 249-j. Furthermore, a connection point between the nMOS transistor 282 and the capacitor 283 is connected to the reset switch 284 and the ADC 285.

The reset switch 284 initializes an amount of charge of the capacitor 283 in accordance with control of the logic circuit 286.

The ADC 285 converts a potential at a connection point between the nMOS transistor 282 and the capacitor 283 into a digital signal and supplies the digital signal to the logic circuit 286.

The logic circuit 286 detects the number of simultaneous reactions on the basis of a digital value (that is, a voltage value of the voltage signal) indicated by the ADC 285. For example, in a case where the number of simultaneous reactions up to four is detected, four threshold values THk (k is an integer of 1 to 4) are set in advance, and the voltage value is converted into k in a case where the voltage value is less than THk, or the like. The logic circuit 286 supplies the detected number of simultaneous reactions to the signal processing unit 400.

Furthermore, when a digital value TDCOUT from the time digital converter 272 is a predetermined value (for example, “1”), the logic circuit 286 controls the reset switch 284 to cause the capacitor 283 to be initialized. As a result, the peak value of the voltage signal within the elapsed time measured by the time digital converter 272 is held in the peak hold circuit 281.

[Configuration Example of Signal Processing Unit]

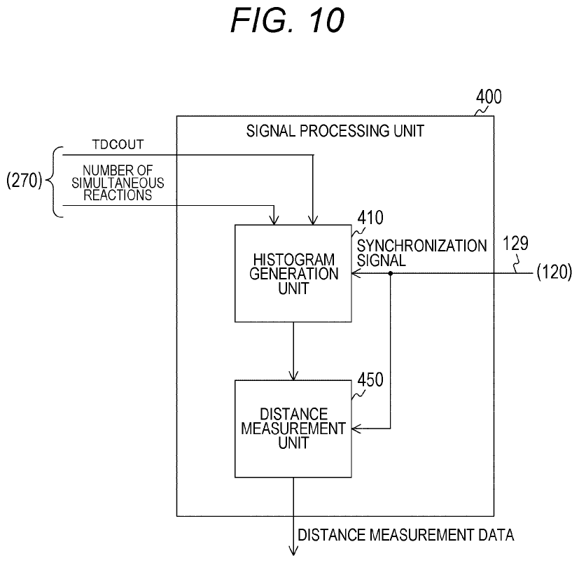

FIG. 10 is a block diagram illustrating a configuration example of the signal processing unit 400 in the first embodiment of the present technology. The signal processing unit 400 includes a histogram generation unit 410 and a distance measurement unit 450.

The histogram generation unit 410 generates a histogram for each number of simultaneous reactions on the basis of the number of simultaneous reactions from the analog-digital conversion unit 270 and the digital value TDCOUT. Here, the histogram is obtained by plotting a detection frequency of the number of simultaneous reactions for each detection timing indicated by the digital value TDCOUT. For example, in a case where the four pixels 305 are arranged in the pixel block 301, the number of simultaneous reactions of up to four is detected, and four histograms are generated. Then, the histogram generation unit 410 synthesizes those histograms and supplies a synthesized histogram to the distance measurement unit 450.

The distance measurement unit 450 measures a distance to a predetermined object for each pixel block 301 on the basis of the histogram from the histogram generation unit 410. The distance measurement unit 450 generates and outputs distance measurement data indicating a measured value for each pixel block 301.

[Configuration Example of Histogram Generation Unit]

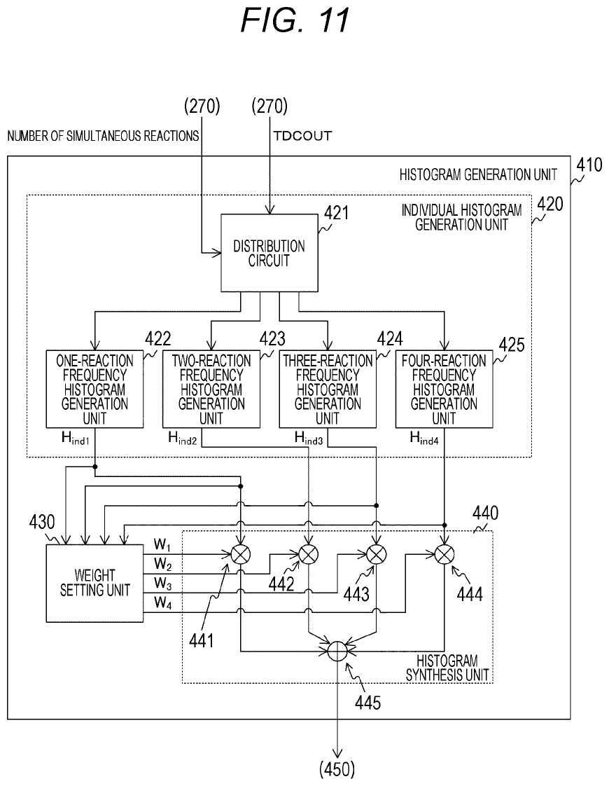

FIG. 11 is a block diagram illustrating a configuration example of the histogram generation unit 410 in the first embodiment of the present technology. The histogram generation unit 410 includes an individual histogram generation unit 420, a weight setting unit 430, and a histogram synthesis unit 440.

The individual histogram generation unit 420 generates a histogram for each number of simultaneous reactions on the basis of the number of simultaneous reactions from the analog-digital conversion unit 270 and the digital value TDCOUT. The individual histogram generation unit 420 includes a distribution circuit 421, a one-reaction frequency histogram generation unit 422, a two-reaction frequency histogram generation unit 423, a three-reaction frequency histogram generation unit 424, and a four-reaction frequency histogram generation unit 425.

The distribution circuit 421 distributes the digital value TDCOUT on the basis of the number of simultaneous reactions. In a case where the number of simultaneous reactions is one, the distribution circuit 421 supplies the digital value TDCOUT at that time to the one-reaction frequency histogram generation unit 422. In a case where the number of simultaneous reactions is two, the distribution circuit 421 supplies the digital value TDCOUT at that time to the two-reaction frequency histogram generation unit 423. Furthermore, in a case where the number of simultaneous reactions is three, the digital value TDCOUT is supplied to the three-reaction frequency histogram generation unit 424, and in a case where the number of simultaneous reactions is four, the digital value TDCOUT is supplied to the four-reaction frequency histogram generation unit 425. Note that, in a case where the number of simultaneous reactions is “zero”, the time digital converter 272 does not react, and thus the digital value TDCOUT is not generated.

The one-reaction frequency histogram generation unit 422 generates, as an individual histogram H_{ind1}, a histogram in which a frequency at which one photon is detected is plotted for each detection timing. The two-reaction frequency histogram generation unit 423 generates, as an individual histogram H_{ind2}, a histogram in which a frequency at which two photons are substantially simultaneously detected is plotted for each detection timing. The three-reaction frequency histogram generation unit 424 generates, as an individual histogram H_{ind3}, a histogram in which a frequency at which three photons are substantially simultaneously detected is plotted for each detection timing. Furthermore, the four-reaction frequency histogram generation unit 425 generates, as an individual histogram H_{ind4}, a histogram in which a frequency at which four photons are substantially simultaneously detected is plotted for each detection timing.

The individual histogram generation unit 420 supplies each of the generated individual histograms H_{ind1} to H_{ind4} to the weight setting unit 430 and the histogram synthesis unit 440.

The weight setting unit 430 sets a weight on the basis of a degree of variation of each of the individual histograms H_{ind1} to H_{ind4}. W₁ to W₄ are set as weights of the individual histograms H_{ind1} to H_{ind4}, respectively. The weight setting unit 430 supplies the set weights W₁ to W₄ to the histogram synthesis unit 440.

The histogram synthesis unit 440 synthesizes the individual histograms H_{ind1} to H_{ind4} The histogram synthesis unit 440 includes multipliers 441 to 444 and an adder 445.

The multiplier 441 multiplies a corresponding detection frequency and the weight W₁ for each detection timing in the individual histogram H_{ind1}. The multiplier 441 supplies a multiplication result to the adder 445.

The multiplier 442 multiplies a corresponding detection frequency and the weight W₂ for each detection timing in the individual histogram H_{ind2}. The multiplier 442 supplies a multiplication result to the adder 445.

The multiplier 443 multiplies a corresponding detection frequency and the weight W₃ for each detection timing in the individual histogram H_{ind3}. The multiplier 443 supplies a multiplication result to the adder 445.

The multiplier 444 multiplies a corresponding detection frequency and the weight W₄ for each detection timing in the individual histogram H_{ind4} The multiplier 444 supplies a multiplication result to the adder 445.

The adder 445 adds the multiplication results of the multipliers 441 to 444 together for each detection timing. The adder 445 outputs an addition result to the distance measurement unit 450 as a detection frequency of a synthesized histogram, for each detection timing.

With the above-described configuration, the individual histograms H_{ind1} to H_{ind4} are synthesized by weighted addition. For example, values of the detection frequencies (that is, frequencies) of the individual histograms H_{ind1} to H_{ind4} at a certain detection timing t are defined as F₁(t) to F₄(t). In this case, a detection frequency Fc(t) of the synthesized histogram at a detection timing t is expressed by the following expression.

Fc(t)=F₁(t)×W₁+F₂(t)×W₂+F₃(t)×W₃+F₄(t)×W₄

Then, the distance measurement unit 450 in the subsequent stage detects a timing of the peak of the synthesized histogram as the incident timing of the reflected light, and converts the round-trip time from the irradiation timing of the irradiation light to the incident timing of the reflected light into the distance to the object.

[Configuration Example of Weight Setting Unit]

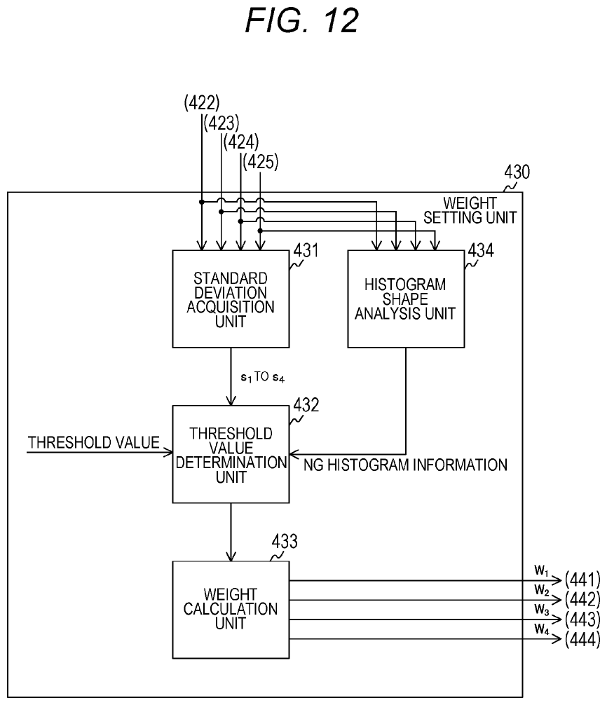

FIG. 12 is a block diagram illustrating a configuration example of the weight setting unit 430 in the first embodiment of the present technology. The weight setting unit 430 includes a standard deviation acquisition unit 431, a threshold value determination unit 432, a weight calculation unit 433, and a histogram shape analysis unit 434.

The standard deviation acquisition unit 431 obtains standard deviations s₁ to s₄ of the individual histograms H_{ind1} to H_{ind4}, respectively. The standard deviation acquisition unit 431 supplies the standard deviations s₁ to s₄ to the threshold value determination unit 432.

The histogram shape analysis unit 434 analyzes a shape of each of the individual histograms H_{ind1} to H_{ind4} The histogram shape analysis unit 434 is provided from a viewpoint of improving security to detect an interference act such as intentionally forming a sharp peak for the purpose of causing erroneous distance measurement. The histogram shape analysis unit 434 generates NG histogram information indicating whether or not the shape of the histogram is unnatural (NG) on the basis of an analysis result and supplies the NG histogram information to the threshold value determination unit 432. For example, it is determined that the shape is NG in a case where there is strong reflected light at the same timing even though it is far away or in a case where presence or absence of background light is in one histogram as a step. Note that, for example, in a case where no security problem occurs, the histogram shape analysis unit 434 does not have to be provided.

The threshold value determination unit 432 compares each of the standard deviations s₁ to s₄ with a predetermined threshold value and determines whether or not each of the standard deviations s₁ to s₄ is less than or equal to the threshold value. The threshold value determination unit 432 supplies the standard deviations s₁ to s₄ and respective determination results to the weight calculation unit 433. However, in a case where the shape of the histogram is NG, comparison with the threshold is not executed for the histogram.

The weight calculation unit 433 calculates the weights W₁ to W₄ on the basis of the respective determination results of the standard deviations s₁ to s₄. First, the weight calculation unit 433 sets “0” as the weight corresponding to the standard deviation exceeding the threshold value.

Furthermore, the weight calculation unit 433 calculates a value depending on the standard deviation as a weight corresponding to the standard deviation less than or equal to the threshold value. For example, when sᵢ is a standard deviation of the i-th (i is an integer) synthesis target histogram among the standard deviations less than or equal to the threshold value, a weight Wᵢ is calculated by the following expression.

$${W}_{i} = \frac{\sum {s}_{i}}{{s}_{1}} \qquad [ Expression 1 ]$$

In the above expression, the denominator expression on the right side means a sum of the standard deviations less than or equal to the threshold value.

For example, it is assumed that the standard deviations s₁, s₂, s₃, and s₄ are “100”, “30”, “25”, and “40”, respectively, and the threshold value is “40”. In this case, since the standard deviation s₁ exceeds the threshold value, “0” is set for the weight W₁.

On the other hand, the weights W₂, W₃, and W₄ are calculated by the following expression on the basis of Expression 1.

W₂=(30+25+40)/30=19/6

W₃=(30+25+40)/25=19/5

W₄=(30+25+40)/40=19/8

The weight calculation unit 433 supplies the calculated weights to the multipliers 441 to 444, respectively.

Note that, although the weight setting unit 430 obtains the standard deviation, it is also possible to obtain a statistic (variance or the like) other than the standard deviation as long as it indicates the degree of variation of the histogram.

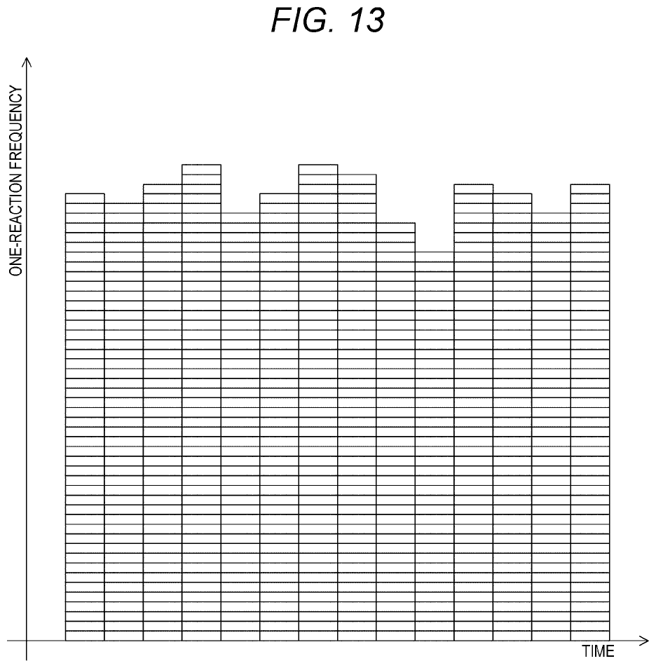

FIG. 13 is a diagram illustrating an example of the individual histogram H_{ind1} of the one-reaction frequency histogram generation unit 422 when noise occurs in the first embodiment of the present technology. In the figure, the vertical axis indicates a frequency at which one reaction is detected as the number of simultaneous reactions, and the horizontal axis indicates a time (that is, a detection timing) indicated by the digital value TDCOUT.

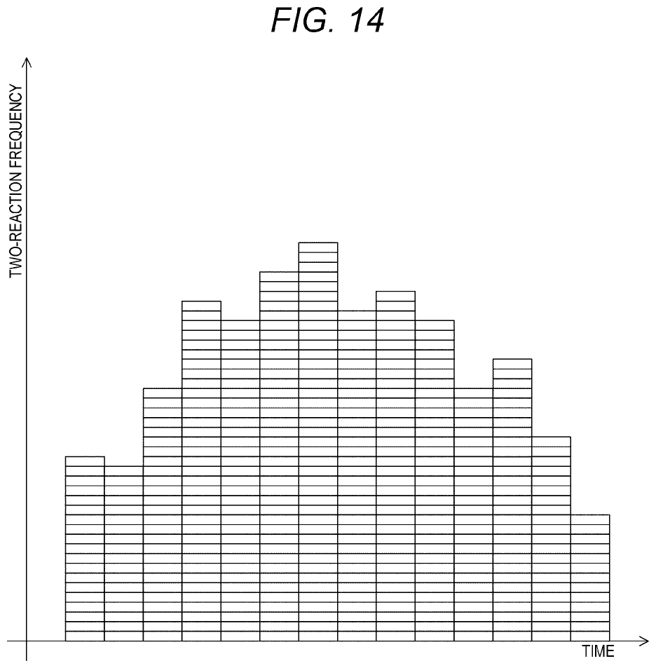

FIG. 14 is a diagram illustrating an example of the individual histogram H_{ind2} of the two-reaction frequency histogram generation unit 423 when noise occurs in the first embodiment of the present technology. In the figure, the vertical axis indicates a frequency at which two reactions are detected as the number of simultaneous reactions, and the horizontal axis indicates a time indicated by the digital value TDCOUT.

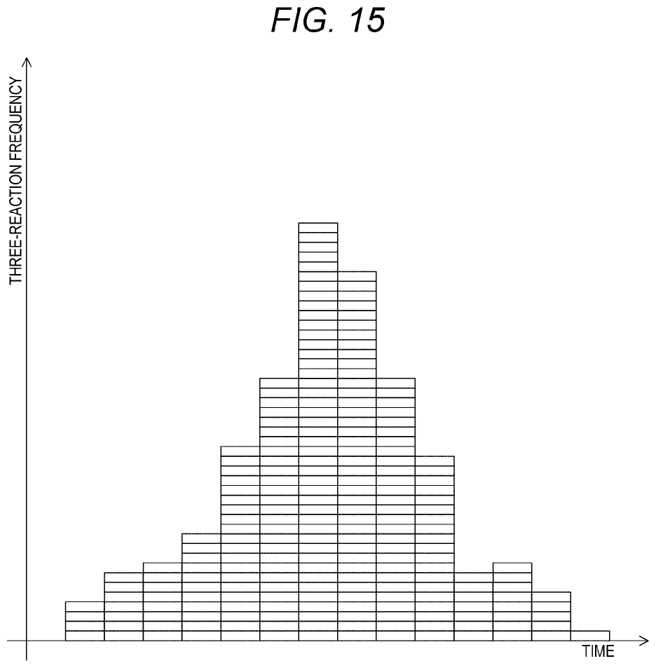

FIG. 15 is a diagram illustrating an example of the individual histogram H_{ind3} of the three-reaction frequency histogram generation unit 424 when noise occurs in the first embodiment of the present technology. In the figure, the vertical axis indicates a frequency at which three reactions are detected as the number of simultaneous reactions, and the horizontal axis indicates a time indicated by the digital value TDCOUT.

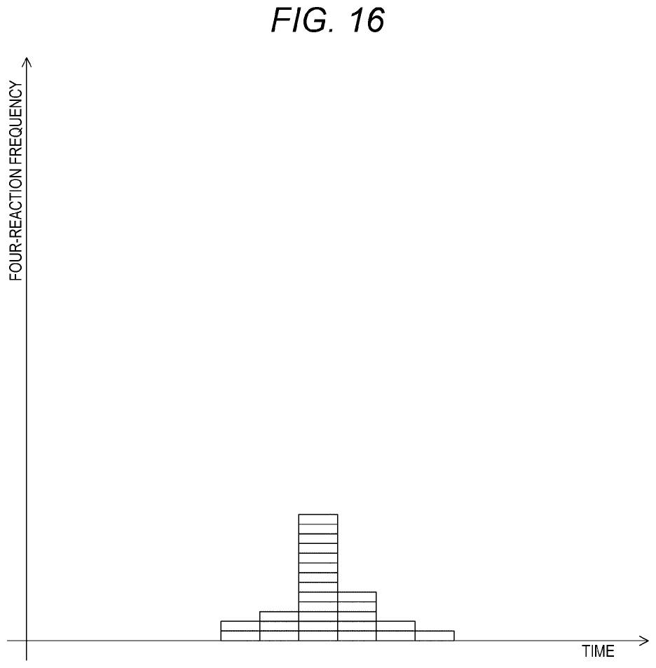

FIG. 16 is a diagram illustrating an example of the individual histogram H_{ind4} of the four-reaction frequency histogram generation unit 425 when noise occurs in the first embodiment of the present technology. In the figure, the vertical axis indicates a frequency at which four reactions are detected as the number of simultaneous reactions, and the horizontal axis indicates a time indicated by the digital value TDCOUT.

When the individual histograms of FIGS. 13 to 16 are compared with each other, as illustrated in FIG. 13, in the histogram in which the number of simultaneous reactions is one, the standard deviation is relatively large, and no peak occurs. On the other hand, as illustrated in FIGS. 14 to 16, in the histogram in which the number of simultaneous reactions is two to four, the standard deviation is relatively small, and a peak occurs. As described above, when noise such as background light occurs, the standard deviation often increases in the histogram in which the number of simultaneous reactions is one.

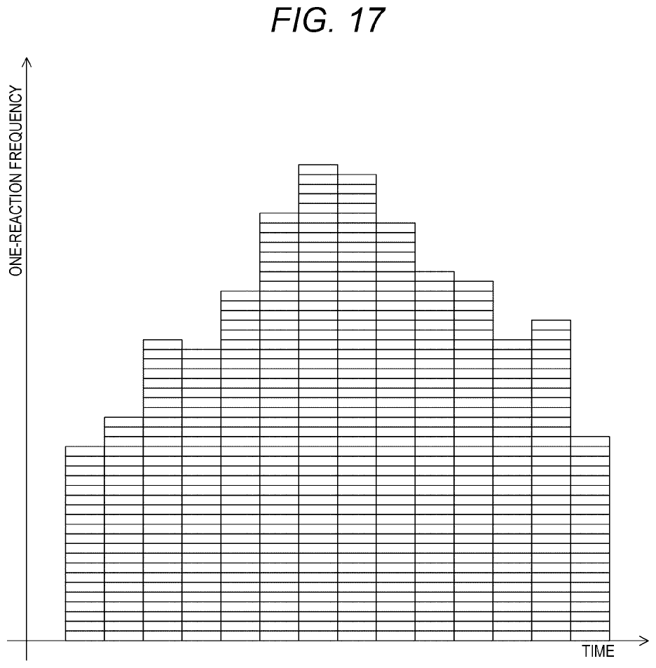

FIG. 17 is a diagram illustrating an example of the individual histogram H_{ind1} of the one-reaction frequency histogram generation unit 422 when disturbance occurs in the first embodiment of the present technology.

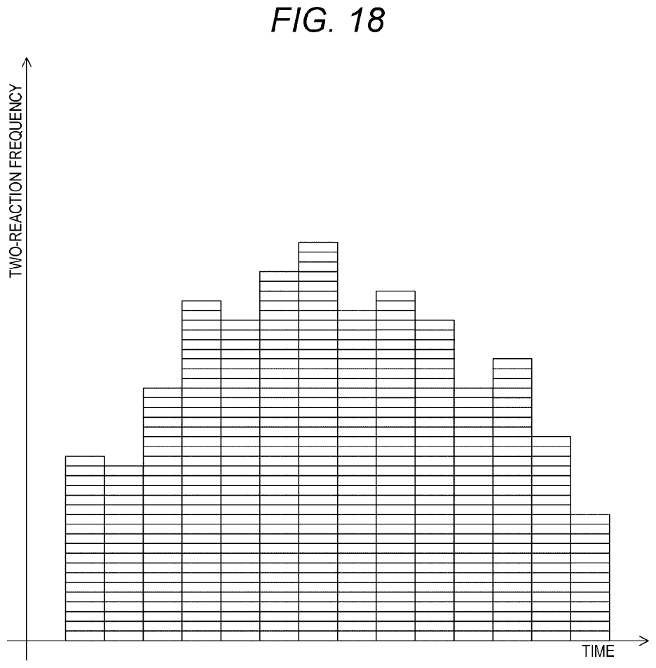

FIG. 18 is a diagram illustrating an example of the individual histogram H_{ind2} of the two-reaction frequency histogram generation unit 423 when disturbance occurs in the first embodiment of the present technology.

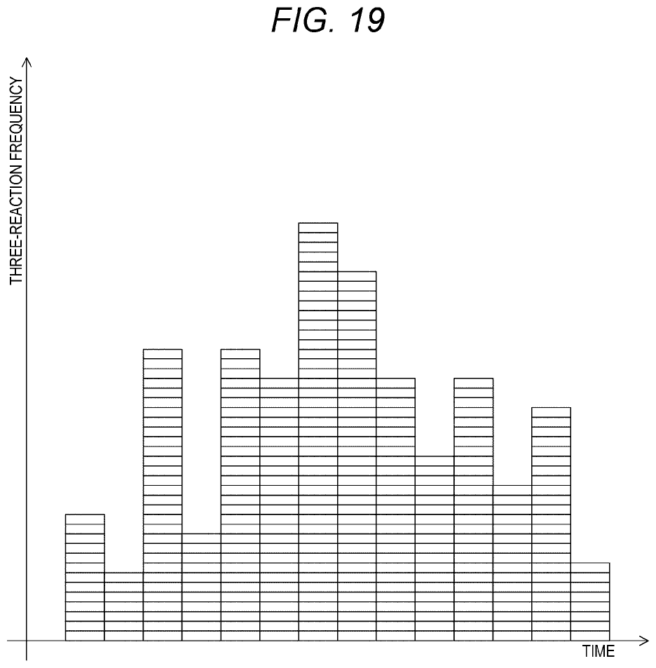

FIG. 19 is a diagram illustrating an example of the individual histogram H_{ind3} of the three-reaction frequency histogram generation unit 424 when disturbance occurs in the first embodiment of the present technology.

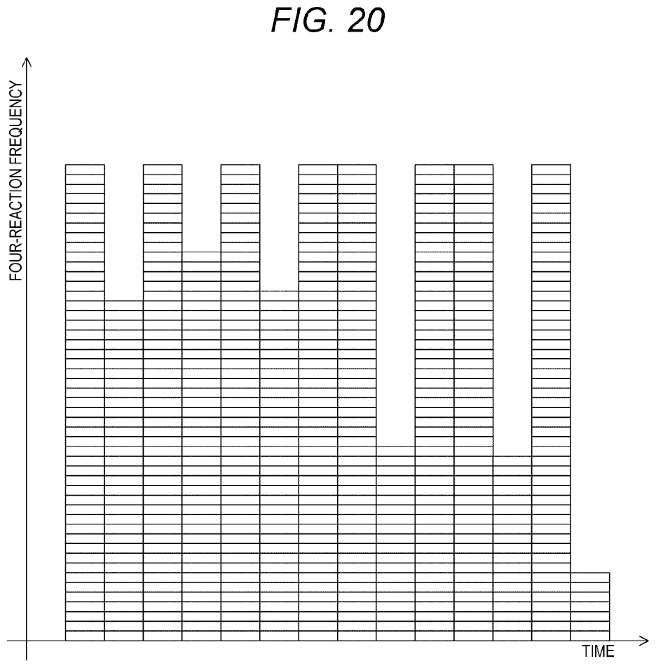

FIG. 20 is a diagram illustrating an example of the individual histogram H_{ind4} of the four-reaction frequency histogram generation unit 425 when disturbance occurs in the first embodiment of the present technology.

When the individual histograms of FIGS. 17 to 20 are compared with each other, as illustrated in FIG. 20, in the histogram in which the number of simultaneous reactions is four, the standard deviation is relatively large, and no peak occurs. On the other hand, as illustrated in FIGS. 17 to 19, in the histogram in which the number of simultaneous reactions is one to three, the standard deviation is relatively small, and a peak occurs. As described above, when disturbance such as instantaneous light emission of an external light source occurs, the standard deviation is often large in the histogram in which the number of simultaneous reactions is four.

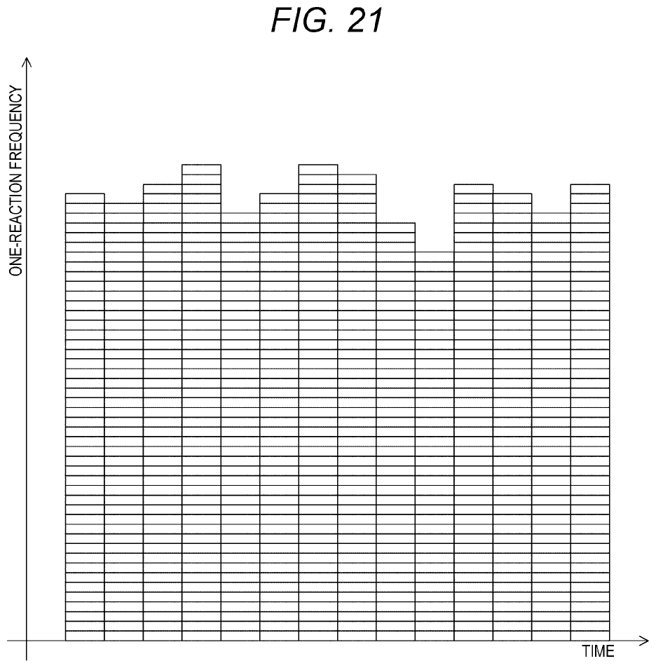

FIG. 21 is a diagram illustrating an example of the individual histogram H_{ind1} of the one-reaction frequency histogram generation unit 422 when noise and disturbance occur in the first embodiment of the present technology.

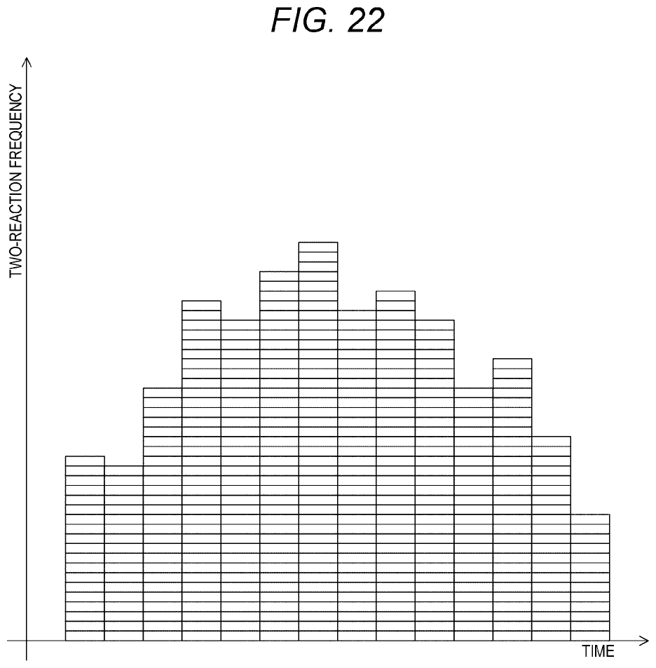

FIG. 22 is a diagram illustrating an example of the individual histogram H_{ind2} of the two-reaction frequency histogram generation unit 423 when noise and disturbance occur in the first embodiment of the present technology.

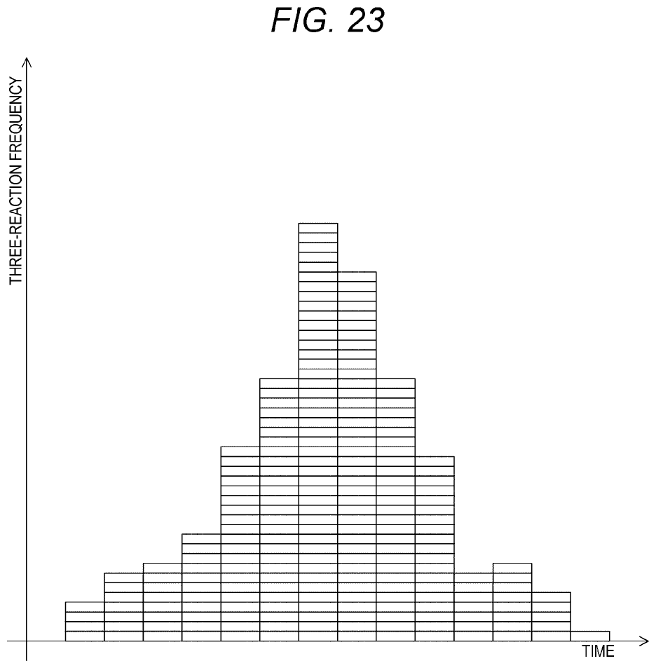

FIG. 23 is a diagram illustrating an example of the individual histogram H_{ind3} of the three-reaction frequency histogram generation unit 424 when noise and disturbance occur in the first embodiment of the present technology.

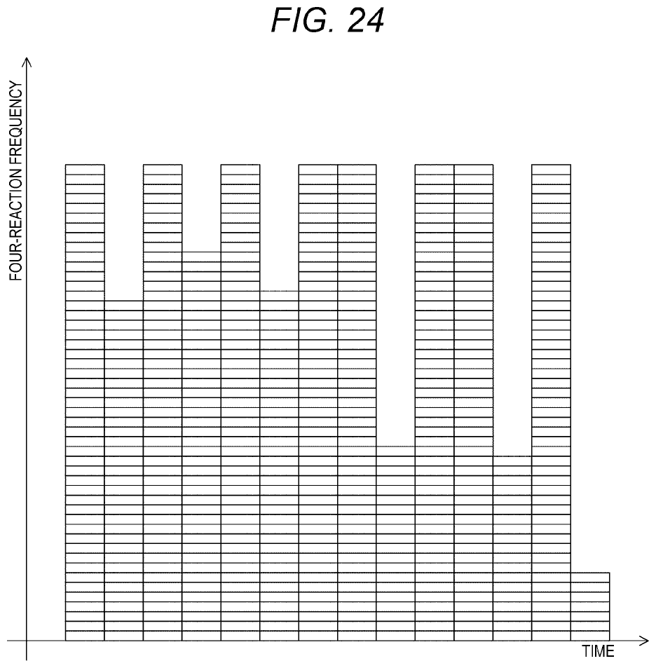

FIG. 24 is a diagram illustrating an example of the individual histogram H_{ind4} of the four-reaction frequency histogram generation unit 425 when noise and disturbance occur in the first embodiment of the present technology.

When the individual histograms of FIGS. 21 to 24 are compared with each other, as illustrated in FIGS. 21 and 24, in the histograms in which the numbers of simultaneous reactions are one and four, the standard deviation is relatively large, and no peak occurs. On the other hand, as illustrated in FIGS. 22 and 23, in the histograms in which the numbers of simultaneous reactions are two and three, the standard deviation is relatively small, and a peak occurs. As described above, when noise and disturbance occur, the standard deviation is often large in the histogram in which the numbers of simultaneous reactions are one and four.

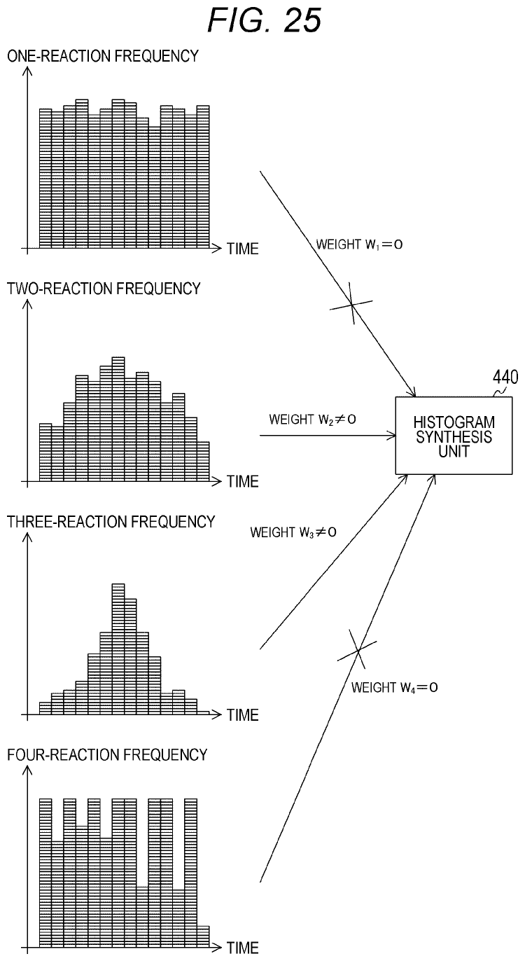

FIG. 25 is a diagram illustrating an example of setting weights in the first embodiment of the present technology. The individual histogram generation unit 420 generates four individual histograms having the numbers of simultaneous reactions different from each other. It is assumed that the standard deviation of each of the individual histogram in which the number of simultaneous reactions is one and the individual histogram in which the number of simultaneous reactions is four is larger than the threshold value due to influence of noise or disturbance.

In this case, the weight setting unit 430 sets “0” for the weights W₁ and W₄ of the individual histogram having the standard deviation larger than the threshold value. On the other hand, the weight setting unit 430 sets values calculated by Expression 1 for the weights W₂ and W₃ of the individual histograms having the standard deviations not exceeding the threshold value.

Then, the histogram synthesis unit 440 synthesizes the four individual histograms with the set weights. In this synthesis, the individual histograms in which the standard deviations are larger than the threshold value and no peak occurs are not synthesized due to the weight of the value “0”. By performing synthesis by excluding the individual histograms in which no peak occurs due to the influence of noise or disturbance in this way, the influence of noise or the like can be suppressed. As a result, the detection accuracy of the peak is improved, and the distance measurement accuracy is improved due to the improvement of the detection accuracy of the peak.

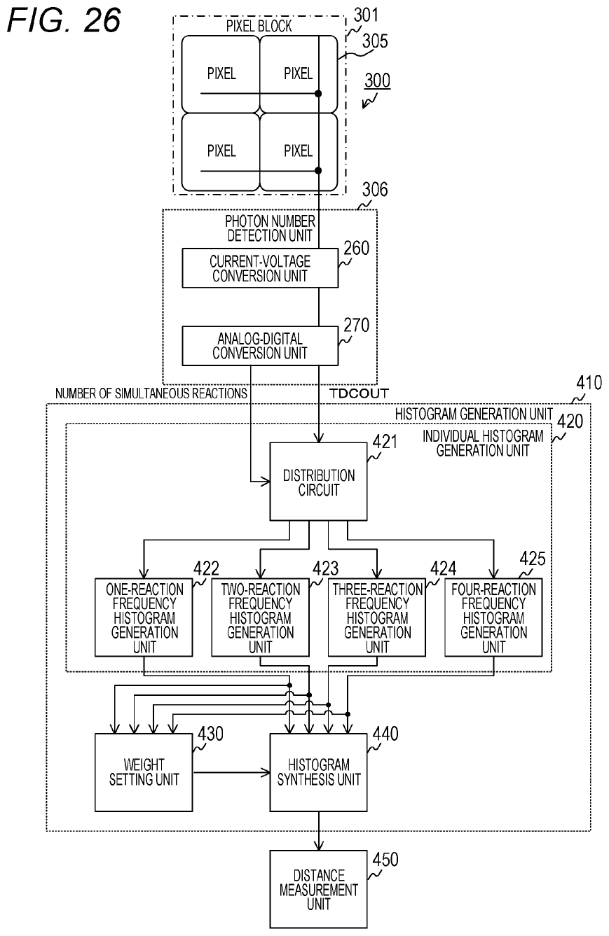

FIG. 26 is a diagram for explaining entire processing from detection of the number of simultaneous reactions to distance measurement in the first embodiment of the present technology.

The pixel array unit 300 is divided into the plurality of pixel blocks 301 each including a plurality of (for example, four) pixels 305 arranged. The current-voltage conversion unit 260 and the analog-digital conversion unit 270 function as a photon number detection unit 306 that detects the number of photons incident substantially simultaneously as the number of simultaneous reactions, over a predetermined number of times, for each of the pixel blocks 301. Then, the photon number detection unit 306 outputs a detection result including the number of simultaneous reactions and the digital value TDCOUT indicating the detection timing to the histogram generation unit 410.

The individual histogram generation unit 420 in the histogram generation unit 410 generates a histogram indicating the detection frequency of the number of simultaneous reactions as a frequency for each detection timing, as an individual histogram for each number of simultaneous reactions (that is, the number of photons) on the basis of the detection result.

The weight setting unit 430 sets a weight depending on the degree of variation (standard deviation or the like) for each individual histogram. Then, the histogram synthesis unit 440 synthesizes histograms in which the degree of variation does not exceed the predetermined threshold value among the individual histograms, and outputs the synthesized histogram to the distance measurement unit 450.

The distance measurement unit 450 measures a distance to the predetermined object for each of the pixel blocks 301 on the basis of the histogram generated by the distance measurement unit 450.

[Operation Example of Solid-State Imaging Element]

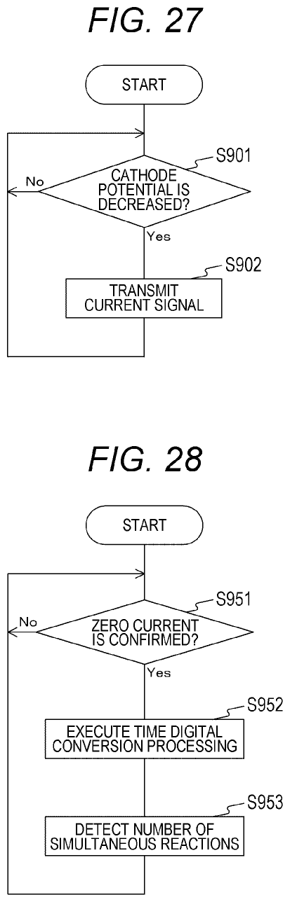

FIG. 27 is a flowchart illustrating an example of operation of the pixel 305 in the first embodiment of the present technology. The operation is started, for example, when a predetermined application for performing distance measurement is executed. First, the pixel 305 determines whether or not the cathode potential of the photoelectric conversion element 222 is decreased (in other words, a photon is incident) (step S901). In a case where the cathode potential is decreased (step S901: Yes), the pixel 305 generates a current signal and transmits the current signal via a signal line (step S902). In a case where the cathode potential is not decreased (step S901: No), or after step S902, the pixel 305 repeatedly executes step S901 and the subsequent step.

FIG. 28 is a flowchart illustrating an example of operation of the analog-digital conversion unit 270 in the first embodiment of the present technology. The operation is started, for example, when a predetermined application for performing distance measurement is executed. The analog-digital conversion unit 270 determines whether or not a zero current is confirmed (step S951).

In a case where the zero current is confirmed (step S951: Yes), the analog-digital conversion unit 270 executes time digital conversion processing (step S952) and detects the number of simultaneous reactions (step S953). In a case where the zero current is not confirmed (step S951: No), or after step S953, the analog-digital conversion unit 270 repeatedly executes step S951 and the subsequent steps.

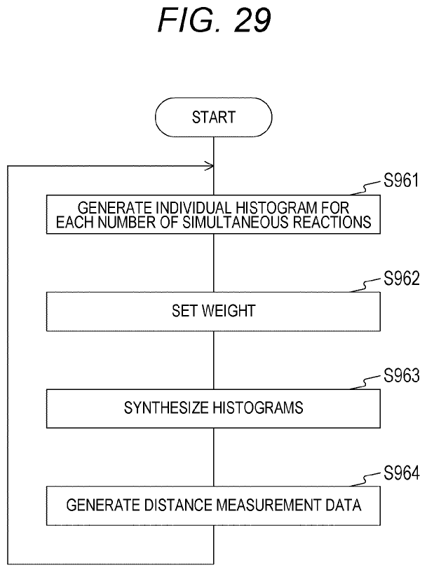

FIG. 29 is a flowchart illustrating an example of operation of the signal processing unit 400 in the first embodiment of the present technology. The operation is started, for example, when a predetermined application for performing distance measurement is executed. The signal processing unit 400 generates an individual histogram for each number of simultaneous reactions (step S961). Then, the signal processing unit 400 sets a weight depending on a standard deviation for each individual histogram (step S962), and synthesizes the individual histograms by weighted addition (step S963). Then, the signal processing unit 400 generates distance measurement data for each pixel block 301 on the basis of the peak of a synthesized histogram (step S964). After step S964, the signal processing unit 400 repeatedly executes step S961 and subsequent steps.

As described above, according to the first embodiment of the present technology, the histogram generation unit 410 generates the individual histogram for each number of simultaneous reactions, and the distance measurement unit 450 performs distance measurement on the basis of the individual histogram having the standard deviation less than or equal to the threshold value, so that it is possible to suppress the influence of noise or disturbance. As a result, the distance measurement accuracy can be improved.

[Modification]

In the first embodiment described above, the histogram generation unit 410 synthesizes four individual histograms for each pixel block 301; however, as data size of the individual histogram or the number of pixel blocks 301 increases, an amount of calculation of synthesis processing increases. A modification of the first embodiment is different from the first embodiment in that the synthesis processing is not performed and a histogram having the minimum standard deviation is selected.

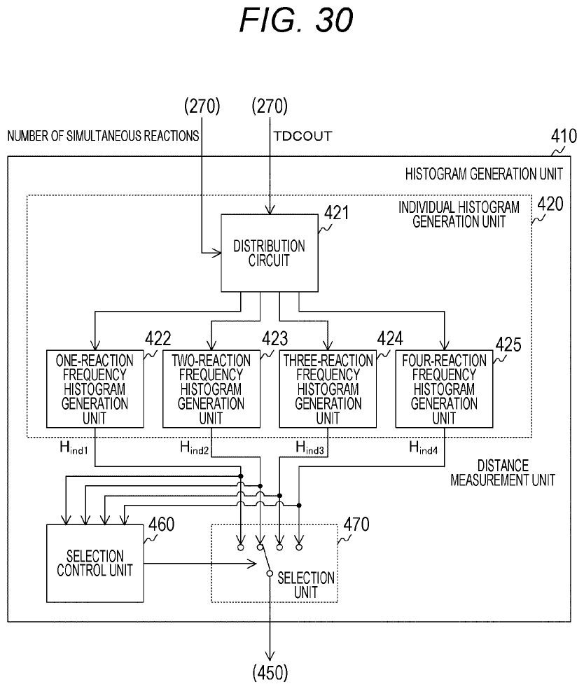

FIG. 30 is a block diagram illustrating a configuration example of the histogram generation unit 410 in the modification of the first embodiment of the present technology. The histogram generation unit 410 of the modification of the first embodiment is different from that of the first embodiment in including a selection control unit 460 and a selection unit 470 instead of the weight setting unit 430 and the histogram synthesis unit 440.

The selection control unit 460 controls the selection unit 470 to select a histogram having the minimum standard deviation among a plurality of (for example, four) individual histograms. The selection control unit 460 receives all the individual histograms from the individual histogram generation unit 420 and acquires respective standard deviations. Then, the selection control unit 460 generates a selection signal for selecting the individual histogram having the minimum standard deviation, and supplies the selection signal to the selection unit 470.

The selection unit 470 selects one of the plurality of individual histograms in accordance with the control of the selection control unit 460. The selection unit 470 supplies the selected individual histogram to the distance measurement unit 450.

As illustrated in the figure, the histogram generation unit 410 selects the histogram with the minimum standard deviation, whereby the distance measurement unit 450 can perform distance measurement without using the histogram in which the standard deviation is increased due to noise or disturbance. As a result, the influence of disturbance of noise can be suppressed, and the distance measurement accuracy can be improved. Furthermore, since the solid-state imaging element 200 does not need to perform histogram synthesis processing, the amount of calculation can be reduced accordingly.

As described above, in the modification of the first embodiment of the present technology, since the histogram generation unit 410 selects the histogram with the minimum standard deviation, it is not necessary to perform the histogram synthesis processing. As a result, the amount of calculation can be reduced.

### 2. Application Example to Mobile Body

The technology according to the present disclosure (the present technology) can be applied to various products. The technology according to the present disclosure may be implemented as a device mounted on any type of mobile body, for example, a car, an electric car, a hybrid electric car, a motorcycle, a bicycle, a personal mobility, an airplane, a drone, a ship, a robot, or the like.

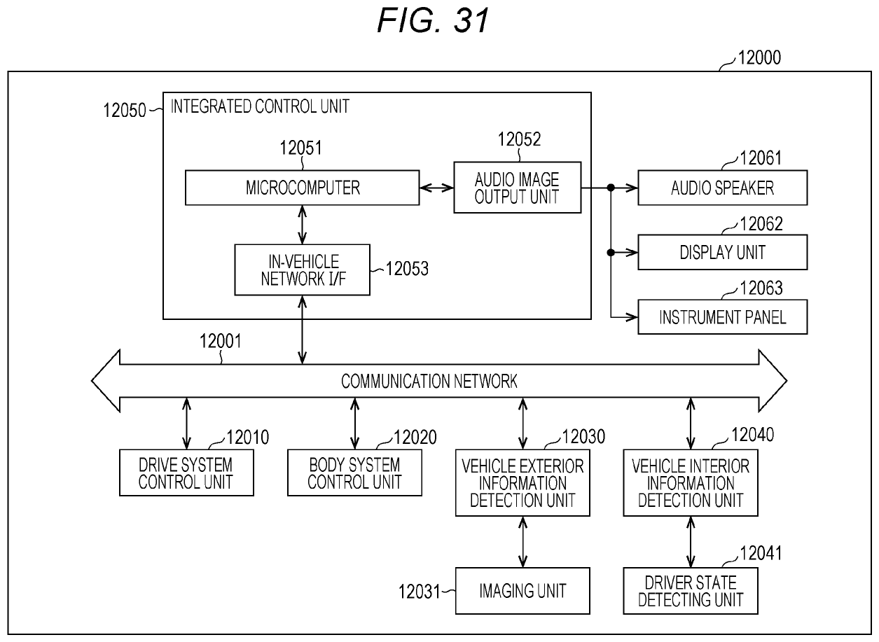

FIG. 31 is a block diagram illustrating a schematic configuration example of a vehicle control system that is an example of a mobile body control system to which the technology according to the present disclosure can be applied.

The vehicle control system 12000 includes a plurality of electronic control units connected to each other via a communication network 12001. In the example illustrated in FIG. 31, the vehicle control system 12000 includes a drive system control unit 12010, a body system control unit 12020, a vehicle exterior information detection unit 12030, a vehicle interior information detection unit 12040, and an integrated control unit 12050. Furthermore, as functional configurations of the integrated control unit 12050, a microcomputer 12051, an audio image output unit 12052, and an in-vehicle network interface (I/F) 12053 are illustrated.

The drive system control unit 12010 controls operation of devices related to a drive system of a vehicle in accordance with various programs. For example, the drive system control unit 12010 functions as a control device of a driving force generating device for generating driving force of the vehicle, such as an internal combustion engine or a driving motor, a driving force transmitting mechanism for transmitting driving force to wheels, a steering mechanism for adjusting a steering angle of the vehicle, a braking device for generating braking force of the vehicle, and the like.

The body system control unit 12020 controls operation of various devices equipped on the vehicle body in accordance with various programs. For example, the body system control unit 12020 functions as a control device of a keyless entry system, a smart key system, a power window device, or various lamps such as a head lamp, a back lamp, a brake lamp, a turn signal lamp, and a fog lamp. In this case, to the body system control unit 12020, a radio wave transmitted from a portable device that substitutes for a key, or signals of various switches can be input. The body system control unit 12020 accepts input of these radio waves or signals and controls a door lock device, power window device, lamp, and the like of the vehicle.

The vehicle exterior information detection unit 12030 detects information on the outside of the vehicle on which the vehicle control system 12000 is mounted. For example, an imaging unit 12031 is connected to the vehicle exterior information detection unit 12030. The vehicle exterior information detection unit 12030 causes the imaging unit 12031 to capture an image outside the vehicle and receives the image captured. The vehicle exterior information detection unit 12030 may perform object detection processing or distance detection processing on a person, a car, an obstacle, a sign, a character on a road surface, or the like, on the basis of the received image.

The imaging unit 12031 is an optical sensor that receives light and outputs an electric signal corresponding to an amount of light received. The imaging unit 12031 can output the electric signal as an image, or as distance measurement information. Furthermore, the light received by the imaging unit 12031 may be visible light, or invisible light such as infrared rays.

The vehicle interior information detection unit 12040 detects information on the inside of the vehicle. The vehicle interior information detection unit 12040 is connected to, for example, a driver state detecting unit 12041 that detects a state of a driver. The driver state detecting unit 12041 includes, for example, a camera that captures an image of the driver, and the vehicle interior information detection unit 12040 may calculate a degree of fatigue or a degree of concentration of the driver, or determine whether or not the driver is dozing, on the basis of the detection information input from the driver state detecting unit 12041.

The microcomputer 12051 can calculate a control target value of the driving force generating device, the steering mechanism, or the braking device on the basis of the information on the inside and outside of the vehicle acquired by the vehicle exterior information detection unit 12030 or the vehicle interior information detection unit 12040, and output a control command to the drive system control unit 12010. For example, the microcomputer 12051 can perform cooperative control aiming for implementing functions of advanced driver assistance system (ADAS) including collision avoidance or shock mitigation of the vehicle, follow-up traveling based on an inter-vehicle distance, vehicle speed maintaining traveling, vehicle collision warning, vehicle lane departure warning, or the like.

Furthermore, the microcomputer 12051 can perform cooperative control aiming for automatic driving that autonomously travels without depending on operation of the driver, or the like, by controlling the driving force generating device, the steering mechanism, the braking device, or the like on the basis of information on the periphery of the vehicle acquired by the vehicle exterior information detection unit 12030 or the vehicle interior information detection unit 12040.

Furthermore, the microcomputer 12051 can output a control command to the body system control unit 12020 on the basis of information on the outside of the vehicle acquired by the vehicle exterior information detection unit 12030. For example, the microcomputer 12051 can perform cooperative control aiming for preventing dazzling such as switching from the high beam to the low beam, by controlling the head lamp depending on a position of a preceding vehicle or an oncoming vehicle detected by the vehicle exterior information detection unit 12030.

The audio image output unit 12052 transmits at least one of audio or image output signal to an output device capable of visually or aurally notifying an occupant in the vehicle or the outside of the vehicle of information. In the example of FIG. 31, as the output device, an audio speaker 12061, a display unit 12062, and an instrument panel 12063 are exemplified. The display unit 12062 may include, for example, at least one of an on-board display or a head-up display.

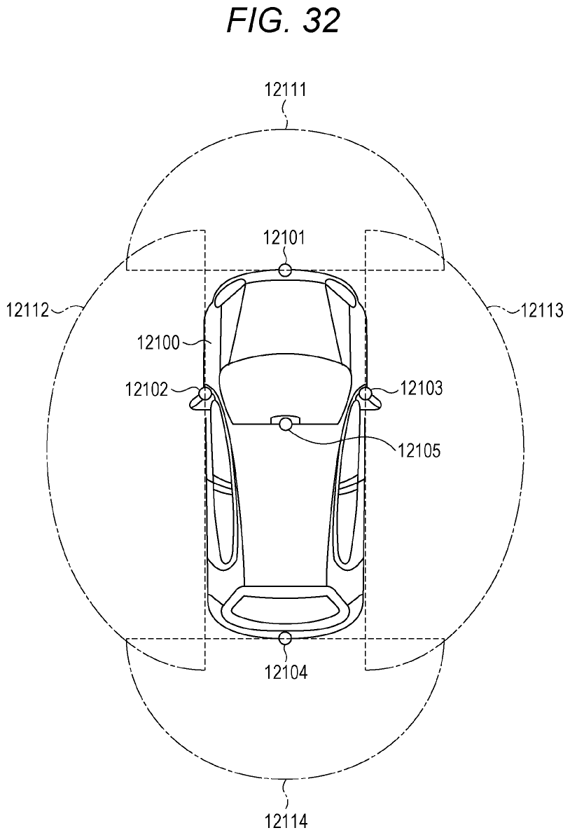

FIG. 32 is a diagram illustrating an example of installation positions of the imaging unit 12031.

In FIG. 32, as the imaging unit 12031, imaging units 12101, 12102, 12103, 12104, and 12105 are included.

The imaging units 12101, 12102, 12103, 12104, and 12105 are provided, for example, at a position of the front nose, the side mirror, the rear bumper, the back door, the upper part of the windshield in the vehicle interior, or the like, of a vehicle 12100. The imaging unit 12101 provided at the front nose and the imaging unit 12105 provided at the upper part of the windshield in the vehicle interior mainly acquire images ahead of the vehicle 12100. The imaging units 12102 and 12103 provided at the side mirrors mainly acquire images on the sides of the vehicle 12100. The imaging unit 12104 provided at the rear bumper or the back door mainly acquires an image behind the vehicle 12100. The imaging unit 12105 provided on the upper part of the windshield in the vehicle interior is mainly used for detecting a preceding vehicle, a pedestrian, an obstacle, a traffic signal, a traffic sign, a lane, or the like.

Note that, FIG. 32 illustrates an example of imaging ranges of the imaging units 12101 to 12104. An imaging range 12111 indicates an imaging range of the imaging unit 12101 provided at the front nose, imaging ranges 12112 and 12113 respectively indicate imaging ranges of the imaging units 12102 and 12103 provided at the side mirrors, an imaging range 12114 indicates an imaging range of the imaging unit 12104 provided at the rear bumper or the back door. For example, image data captured by the imaging units 12101 to 12104 are superimposed on each other, whereby an overhead image is obtained of the vehicle 12100 viewed from above.

At least one of the imaging units 12101 to 12104 may have a function of acquiring distance information. For example, at least one of the imaging units 12101 to 12104 may be a stereo camera including a plurality of imaging elements, or may be an imaging element including pixels for phase difference detection.

For example, on the basis of the distance information obtained from the imaging units 12101 to 12104, the microcomputer 12051 obtains a distance to each three-dimensional object within the imaging ranges 12111 to 12114, and a temporal change of the distance (relative speed to the vehicle 12100), thereby being able to extract, as a preceding vehicle, a three-dimensional object that is in particular a closest three-dimensional object on a traveling path of the vehicle 12100 and traveling at a predetermined speed (for example, greater than or equal to 0 km/h) in substantially the same direction as that of the vehicle 12100. Moreover, the microcomputer 12051 can set an inter-vehicle distance to be ensured in advance in front of the preceding vehicle, and can perform automatic brake control (including follow-up stop control), automatic acceleration control (including follow-up start control), and the like. As described above, it is possible to perform cooperative control aiming for automatic driving that autonomously travels without depending on operation of the driver, or the like.

For example, on the basis of the distance information obtained from the imaging units 12101 to 12104, the microcomputer 12051 can extract three-dimensional object data regarding the three-dimensional object by classifying the objects into a two-wheeled vehicle, a regular vehicle, a large vehicle, a pedestrian, and other three-dimensional objects such as a utility pole, and use the data for automatic avoidance of obstacles. For example, the microcomputer 12051 identifies obstacles in the periphery of the vehicle 12100 into an obstacle visually recognizable to the driver of the vehicle 12100 and an obstacle difficult to visually recognize. Then, the microcomputer 12051 determines a collision risk indicating a risk of collision with each obstacle, and when the collision risk is greater than or equal to a set value and there is a possibility of collision, the microcomputer 12051 outputs an alarm to the driver via the audio speaker 12061 and the display unit 12062, or performs forced deceleration or avoidance steering via the drive system control unit 12010, thereby being able to perform driving assistance for collision avoidance.

At least one of the imaging units 12101 to 12104 may be an infrared camera that detects infrared rays. For example, the microcomputer 12051 can recognize a pedestrian by determining whether or not a pedestrian exists in the captured images of the imaging units 12101 to 12104. Such pedestrian recognition is performed by, for example, a procedure of extracting feature points in the captured images of the imaging units 12101 to 12104 as infrared cameras, and a procedure of performing pattern matching processing on a series of feature points indicating a contour of an object to determine whether or not the object is a pedestrian. When the microcomputer 12051 determines that a pedestrian exists in the captured images of the imaging units 12101 to 12104 and recognizes the pedestrian, the audio image output unit 12052 controls the display unit 12062 so that a rectangular contour line for emphasis is superimposed and displayed on the recognized pedestrian. Furthermore, the audio image output unit 12052 may control the display unit 12062 so that an icon or the like indicating the pedestrian is displayed at a desired position.

In the above, an example has been described of the vehicle control system to which the technology according to the present disclosure can be applied. The technology according to the present disclosure can be applied to, for example, the vehicle exterior information detection unit 12030 among the configurations described above. Specifically, the distance measurement module 100 of FIG. 1 can be applied to the vehicle exterior information detection unit 12030. By applying the technology according to the present disclosure to the vehicle exterior information detection unit 12030, the influence of noise or disturbance can be suppressed, so that the distance measurement accuracy can be improved.

Note that, the embodiments described above each describe an example for embodying the present technology, and matters in the embodiments and matters specifying the invention in the claims have correspondence relationships. Similarly, the matters specifying the invention in the claims and the matters in the embodiments of the present technology denoted by the same names have correspondence relationships. However, the present technology is not limited to the embodiments, and can be embodied by subjecting the embodiments to various modifications without departing from the gist thereof.

Note that, the advantageous effects described in the specification are merely examples, and the advantageous effects of the present technology are not limited to them and may include other effects.

Note that, the present technology can also be configured as described below.

(1) A solid-state imaging element including:

a photon number detection unit that detects the number of photons incident on a pixel array unit over a predetermined number of times and outputs a detection result including the number of photons and a detection timing;

a histogram generation unit that generates, for each number of photons, a histogram indicating a detection frequency of the number of photons as a frequency for each detection timing, on the basis of the detection result; and

a distance measurement unit that measures a distance to a predetermined object on the basis of the histogram generated.

(2) The solid-state imaging element according to (1), in which

the histogram generation unit includes:

an individual histogram generation unit that generates the histogram for each number of photons as an individual histogram on the basis of the detection result; and

a histogram synthesis unit that synthesizes histograms in which a degree of variation does not exceed a predetermined threshold value among a plurality of the individual histograms and outputs a synthesized histogram to the distance measurement unit.

(3) The solid-state imaging element according to (2), in which

the histogram generation unit further includes a weight setting unit that sets a weight depending on the degree of variation for each of the individual histograms, and

the histogram synthesis unit performs weighted addition of the detection frequency of each of the individual histograms by the set weight.

(4) The solid-state imaging element according to (2) or (3), in which

the degree of variation is a standard deviation.

(5) The solid-state imaging element according to (1), in which

the histogram generation unit includes:

an individual histogram generation unit that generates the histogram as an individual histogram for each number of photons on the basis of the detection result; and

a selection unit that selects a histogram of which the degree of variation is minimum among a plurality of the individual histograms and outputs the histogram selected to the distance measurement unit.

(6) The solid-state imaging element according to any of (1) to (5), in which

the pixel array unit is divided into a plurality of pixel blocks in each of which a plurality of pixels is arranged,

the photon number detection unit detects the number of photons for each of the plurality of pixel blocks,

the histogram generation unit generates the histogram for each of the plurality of pixel blocks, and

the distance measurement unit measures the distance for each of the plurality of pixel blocks.

(7) An electronic device including:

a light emitting unit that emits light in synchronization with a predetermined synchronization signal;

a photon number detection unit that detects the number of photons incident on a pixel array unit over a predetermined number of times and outputs a detection result including the number of photons and a detection timing;

a histogram generation unit that generates, for each number of photons, a histogram indicating a detection frequency of the number of photons as a frequency for each detection timing, on the basis of the detection result; and

a distance measurement unit that measures a distance to a predetermined object on the basis of the histogram generated.

(8) A method for controlling a solid-state imaging element, the method including:

a photon number detection procedure of detecting the number of photons incident on a pixel array unit over a predetermined number of times and outputting a detection result including the number of photons and a detection timing;

a histogram generation procedure of generating, for each number of photons, a histogram indicating a detection frequency of the number of photons as a frequency for each detection timing, on the basis of the detection result; and

a distance measurement procedure of measuring a distance to a predetermined object on the basis of the histogram generated.

### REFERENCE SIGNS LIST

100 Distance measurement module
110 Light emitting unit
120 Control unit
200 Solid-state imaging element
201 Light receiving chip
202 Logic chip
210 Light receiving unit
220 Light receiving circuit
221 Resistor
222 Photoelectric conversion element
230 Analog circuit accessory
240 Current signal generation unit
241 Circuit block
250 Current supply circuit
251 Inverter
252 Monostable multivibrator
253 Current source transistor
260 Current-voltage conversion unit
270 Analog-digital conversion unit
271 Zero current confirmation circuit
272 Time digital converter
280 Simultaneous reaction number detection circuit
281 Peak hold circuit
282 nMOS transistor
283 Capacitor
284 Reset switch
285 ADC
286 Logic circuit
300 Pixel array unit
301 Pixel block
305 Pixel
306 Photon number detection unit
400 Signal processing unit
410 Histogram generation unit
420 Individual histogram generation unit
421 Distribution circuit
422 One-reaction frequency histogram generation unit
423 Two-reaction frequency histogram generation unit
424 Three-reaction frequency histogram generation unit
425 Four-reaction frequency histogram generation unit
430 Weight setting unit
431 Standard deviation acquisition unit
432 Threshold value determination unit
433 Weight calculation unit
434 Histogram shape analysis unit
440 Histogram synthesis unit
441 to 444 Multiplier
445 Adder
450 Distance measurement unit
460 Selection control unit
470 Selection unit
12030 Vehicle exterior information detection unit

1. A solid-state imaging element comprising:
a photon number detection unit that detects a number of photons incident on a pixel array unit over a predetermined number of times and outputs a detection result including the number of photons and a detection timing;
a histogram generation unit that generates, for each number of photons, a histogram indicating a detection frequency of the number of photons as a frequency for each detection timing, on a basis of the detection result; and
a distance measurement unit that measures a distance to a predetermined object on a basis of the histogram generated.

2. The solid-state imaging element according to claim 1, wherein
the histogram generation unit includes:
an individual histogram generation unit that generates the histogram for each number of photons as an individual histogram on a basis of the detection result; and
a histogram synthesis unit that synthesizes histograms in which a degree of variation does not exceed a predetermined threshold value among a plurality of the individual histograms and outputs a synthesized histogram to the distance measurement unit.

3. The solid-state imaging element according to claim 2, wherein
the histogram generation unit further includes a weight setting unit that sets a weight depending on the degree of variation for each of the individual histograms, and
the histogram synthesis unit performs weighted addition of the detection frequency of each of the individual histograms by the set weight.

4. The solid-state imaging element according to claim 2, wherein
the degree of variation is a standard deviation.

5. The solid-state imaging element according to claim 1, wherein
the histogram generation unit includes:
an individual histogram generation unit that generates the histogram as an individual histogram for each number of photons on a basis of the detection result; and
a selection unit that selects a histogram of which the degree of variation is minimum among a plurality of the individual histograms and outputs the histogram selected to the distance measurement unit.

6. The solid-state imaging element according to claim 1, wherein
the pixel array unit is divided into a plurality of pixel blocks in each of which a plurality of pixels is arranged,
the photon number detection unit detects the number of photons for each of the plurality of pixel blocks,
the histogram generation unit generates the histogram for each of the plurality of pixel blocks, and
the distance measurement unit measures the distance for each of the plurality of pixel blocks.

7. An electronic device comprising:
a light emitting unit that emits light in synchronization with a predetermined synchronization signal;
a photon number detection unit that detects a number of photons incident on a pixel array unit over a predetermined number of times and outputs a detection result including the number of photons and a detection timing;
a histogram generation unit that generates, for each number of photons, a histogram indicating a detection frequency of the number of photons as a frequency for each detection timing, on a basis of the detection result; and
a distance measurement unit that measures a distance to a predetermined object on a basis of the histogram generated.

8. A method for controlling a solid-state imaging element, the method comprising:
a photon number detection procedure of detecting a number of photons incident on a pixel array unit over a predetermined number of times and outputting a detection result including the number of photons and a detection timing;
a histogram generation procedure of generating, for each number of photons, a histogram indicating a detection frequency of the number of photons as a frequency for each detection timing, on a basis of the detection result; and
a distance measurement procedure of measuring a distance to a predetermined object on a basis of the histogram generated.
